(19) United States
(12) Patent Application Publication
(10) Pub. No.: US 2008/0190308 A1
(43) Pub. Date: Aug. 14, 2008

(54) Image forming apparatus and computer-readable medium

(75) Inventors: Masakatsu Kiwada, Tokyo (JP); Naoya Misawa, Tokyo (JP)

Correspondence Address: BUCHANAN, INGERSOLL & ROONEY PC, POST OFFICE BOX 1404, ALEXANDRIA, VA, 22313-1404, US

(73) Assignee: Konica Minolta business Technologies, Inc., Tokyo (JP)

(21) Appl. No.: 11/806,812

(22) Filed: Jun. 4, 2007

(30) Foreign Application Priority Data
Feb. 13, 2007 (JP) 2007-031923

(51) Int. Cl. B41J 11/66

(52) U.S. Cl. 101/93.07; 358/1.18

(57) ABSTRACT

Disclosed is an image forming apparatus to perform image forming processing based on a print job, including: a sheet feeding section to feed a stored printing sheet, and a control section to allow the sheet feeding section to feed a pre-punched printing sheet with a previously formed punched hole which corresponds to a punched hole to be obtained by a punching processing specified by the print job, when the image forming processing based on the print job is performed.

### CROSS-REFERENCE TO RELATED APPLICATIONS

The present U.S. patent application claims a priority under the Paris Convention of Japanese patent application No. 2007-031923 filed on Feb. 13, 2007, which shall be a basis of correction of an incorrect translation.

### BACKGROUND

1. Field of the Invention

The present invention relates to an image forming apparatus which perform an image forming processing based on a print job which specifies execution of punching processing, and a computer-readable medium.

2. Description of Related Art

Lately, various types of printing sheets such as printing sheets with a pre-punched hole, printing sheets with a tab, etc. are used in image forming apparatuses such as printers, etc. Particularly, the JDF (Job Definition Format) standard, which is predicted to become the mainstream in the future, provides in an attribute of a printing sheet, “pre-punched hole presence” indicating whether a punched hole is present, and “pre-punched hole attribute” indicating the number, spacing, etc. of the punched hole(s).

Along with the use of such various types of printing sheets, the related techniques for image forming apparatus have been developed.

For example, a technique can be given, where, a position of a tab of a fed printing sheet is detected and, if the printing sheet does not have a tab for the image to be formed, the sheet is ejected without any image being formed, and if the printing sheet with a tab for the image to be formed is fed, an image is formed (Japanese Patent Application Laid-Open Publication No. 2001-13823).

Also, another technique can be given, where, even if the carried printing sheet has a pre-punched hole, the sheet is detected without false detection, and thus the sheet is stably supplied without being damaged (Japanese Patent Application Laid-Open Publication No. 11-59960).

However, the technique of Japanese Patent Application Laid-Open Publication No. 2001-13823 is to control whether or not to execute the printing depending on the attribute of the printing sheet (for example, the presence of a tab and the characteristics of the tab, in Japanese Patent Application Laid-Open Publication No. 2001-13823). If the printing sheet to be fed is not the printing sheet with the attribute specified by the user, the user must load the printing sheet of the specified attribute, which lays a heavy burden on the users.

Alternatively, in the technique of Japanese Patent Application Laid-Open Publication No. 11-59960, when printing sheet without a punched hole is carried, if the user desires to form an image on a pre-punched printing sheet, the user must load the pre-punched printing sheet into the sheet feeding section—or, the user must perform the punching processing on the printing sheet by himself subsequent to the image forming on the printing sheet without a punched hole. Thus, as in the case of Japanese Patent Application Laid-Open Publication No. 2001-13823, a heavy burden has been laid on the user.

Also, even if an image forming apparatus comprises a punching section, there are cases where the user desires to form an image on a printing sheet with a punched hole, though, the punching section is unworkable for some reason. In such cases, the user must execute the punching processing by himself to the printing sheet to which the punching processing has not been performed, which lays a heavy burden on the user.

### SUMMARY

The present invention was made in order to settle the above problems. It is one of the objects of the present invention to reduce the burden on the users when the image forming apparatus cannot perform the punching processing to a printing sheet.

To achieve at least one of the above objects, an image forming apparatus reflecting one aspect of the present invention, comprises: a sheet feeding section to feed a stored printing sheet, and a control section to allow the sheet feeding section to feed a pre-punched printing sheet with a previously formed punched hole which corresponds to a punched hole to be obtained by a punching processing specified by the print job, when the image forming processing based on the print job is performed.

Preferably, The image forming apparatus further comprises: a punching section to perform punching processing to a printing sheet, wherein the control section determines whether or not the punching processing specified by the print job is executable on the punching section, and when the punching processing is determined to be executable, the control section allows the punching section to perform the specified punching processing to a printing sheet without the punched hole fed by the sheet feeding section, and when the punching processing is determined to be inexecutable, the control section allows the sheet feeding section to feed the pre-punched printing sheet with the previously formed punched hole which corresponds to the punched hole to be obtained by the specified punching processing.

Preferably, the control section determines whether or not the punching processing is executable, by referring to a punched hole attribute practical by the punching section, and presence or absence of a punched hole in the printing sheet stored in the sheet feeding section.

Preferably, the control section refers to presence or absence of a punched hole and an attribute of the punched hole in the printing sheet stored in the sheet feeding section, and allows the sheet feeding section to feed the pre-punched printing sheet with the previously formed punched hole which corresponds to the punched hole to be obtained by the punching processing specified by the print job.

Preferably, the image forming apparatus further comprises: an operating section to receive an input of the presence or absence of the punched hole and the attribute of the punched hole in the printing sheet stored in the sheet feeding section, and wherein the control section refers to the input.

Preferably, the sheet feeding section includes an optical sensor to detect the presence or absence of the punched hole and the attribute of the punched hole in the printing sheet stored in the sheet feeding section, and the control section refers to information detected by the optical sensor.

Preferably, the control section performs the determination with respect to each page of the printing sheet.

### BRIEF DESCRIPTION OF THE DRAWINGS

These and other objects, features and advantages of the present invention will become more fully understood from the detailed description given hereinbelow and the appended drawings, and thus are not intended as a definition of the limits of the present invention, and wherein;

FIG. 1 is a diagram configuration of an image forming apparatus;

FIG. 2 is a block diagram of the image forming apparatus;

FIG. 3 is a flow chart of image forming processing;

FIG. 4 is a diagram of a data configuration of print job information;

FIG. 5 is a diagram of a data configuration of punching function information;

FIG. 6 is a diagram of a data configuration of punched hole attribute information;

FIG. 7 is a diagram of a data configuration of sheet feeding section information;

FIG. 8 is an example of a printing sheet supply screen;

FIG. 9 is an example of a punching processing inexecutable screen.

### DETAILED DESCRIPTION OF THE PREFERRED EMBODIMENTS

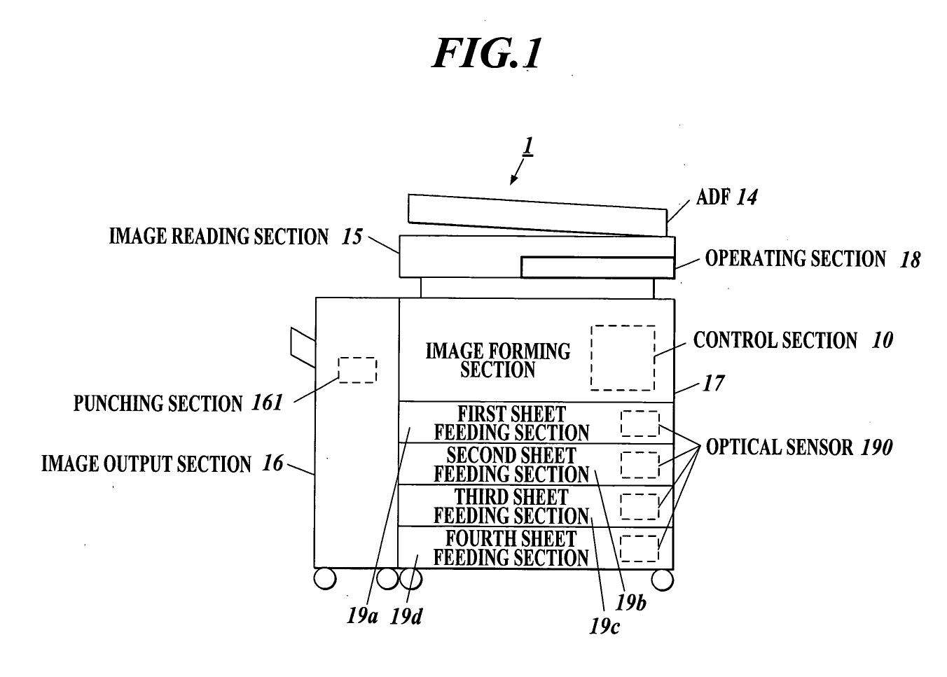

Hereinafter, embodiments of the present invention are described in detail with reference to FIG. 1 to FIG. 9.

### [Functional Configuration of an Image Forming Apparatus]

FIG. 1 shows a configuration of an image forming apparatus. An image forming apparatus 1 is an apparatus which forms an image on a recording medium such as a printing sheet, etc. and comprises a control section 10, an ADF (Auto Document Feeder) 14, an image reading section 15, an image output section 16, an image forming section 17, an operating section 18, a first sheet feeding section 19a, a second sheet feeding section 19b, a third sheet feeding section 19c, and a fourth sheet feeding section 19d.

The ADF 14 is an automatic document feeder, which automatically conveys one or plural sheets of an original document to the image reading section 15.

The image reading section 15 is a functional section to read optically an image of an original document on an original document stage so as to form image data. Specifically, the image reading section 15 optically scans an original document conveyed by the ADF 14 through a contact glass or optically scans a document placed on a platen glass, and allows a CCD (Charge-Coupled Device) image sensor to perform a photoelectric conversion, so as to read the image recorded on the original document. Then the image reading section 15 generates the image data of the read image to output it to the image forming section 17.

The image forming section 17 is a functional section to form an image, and comprises a photoreceptor, a transfer belt, a fuser, various carrier belts, etc. (all not shown). The image forming apparatus 17 forms an image on a printing sheet according to image data read by the image reading section 15 or a print job received through the communication I/F section, and sends the printing sheet to the image output section 16. As a method of forming an image, well-known imaging processing such as electrophotography, electrostatic recording, etc. is used.

The control section 10 controls each functional section, and comprises a CPU (Central Processing Unit), a RAM (Random Access Memory), a storing section, etc. A detailed explanation is given below.

The first sheet feeding section 19a, the second sheet feeding section 19b, the third sheet feeding section 19c, and the fourth sheet feeding section 19d store a printing sheet, and also put out the stored printing sheet to the image forming section 17. Each sheet feeding section includes an optical sensor 190 which detects “pre-punched hole presence”, “pre-punched hole attribute”, etc., of the printing sheet. Hereinafter, the first sheet feeding section 19a to the fourth sheet feeding section 19d are collectively referred to as a sheet feeding section 19.

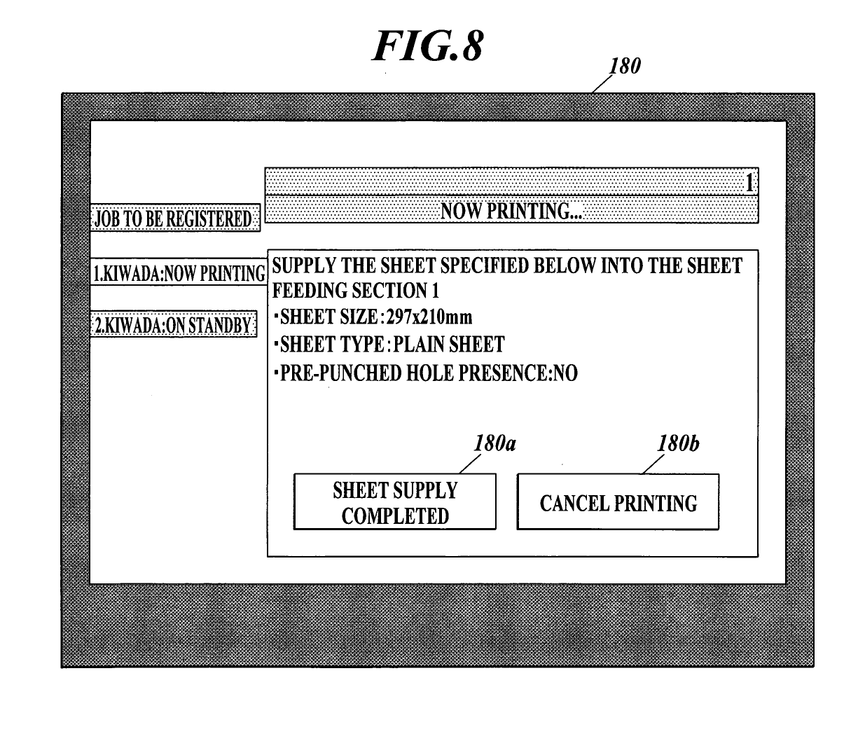

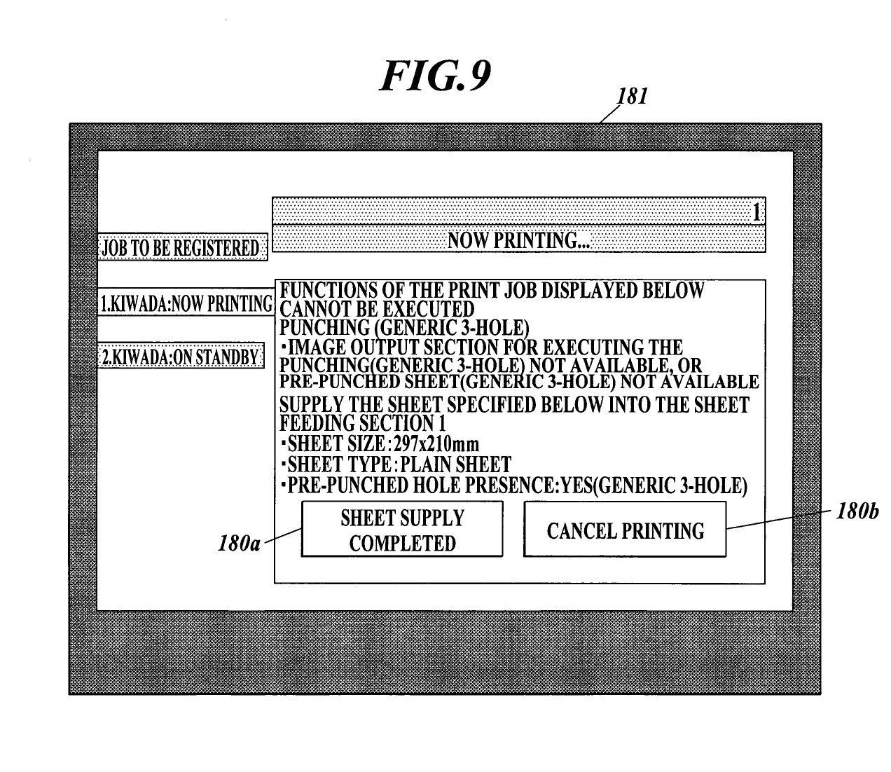

The operating section 18 comprises an operation input key, a touch panel, etc., and outputs an operation signal to the control section 10, such as a push-down signal corresponding to the key pushed down and a positional signal corresponding to the location touched on the touch panel. The operating section 18 displays a warning to the user concerning the punching execution as shown in the example screen of “printing sheet supply screen” in FIG. 8 and “punching inexecutable screen” in FIG. 9. Along with the warning, the operating section 18 displays choices to determine whether to supply a printing sheet to execute the printing or to cancel the printing.

The user uses the touch panel included in the operating section 18 to perform operations described below such as an operation of setting print job information, operation of starting printing, etc.

The image output section 16 is the functional section to perform finishing processing such as punching, stapling, binding, etc., to the sheet conveyed from the image forming section 17 according to an instruction from the control section 10 and then to output the sheet. The image output section 16 includes a punching section 161 for punching a hole in a printing sheet. An attribute of a punched hole which can be punched by the punching section 161 depends on the characteristics of the punching section 161.

[The Functional Configuration and the Data Configuration of the Control Section]

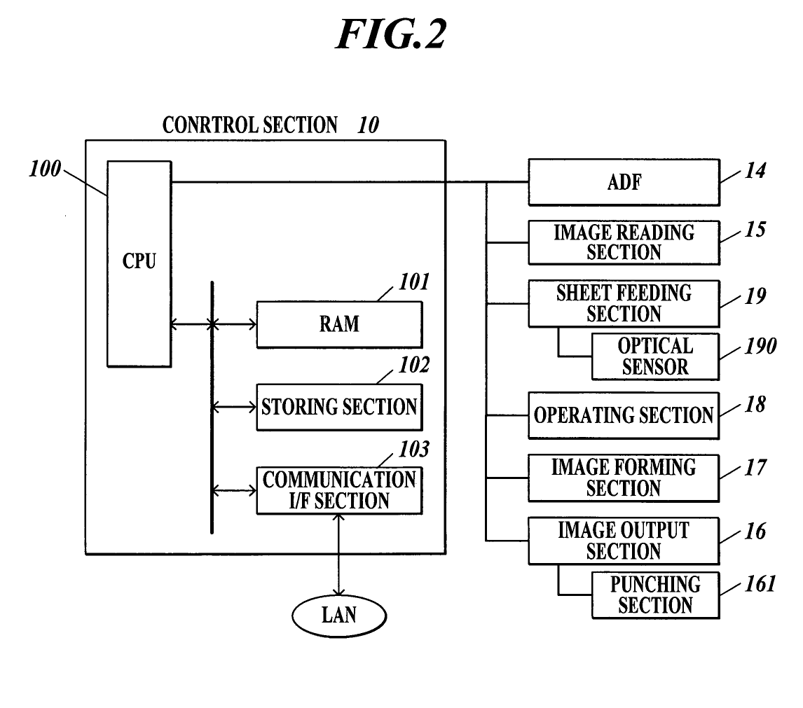

FIG. 2 is a block diagram of the control section 10 and various functional sections. The control section 10 comprises a CPU 100, a RAM 101, a storing section 102 and a communication I/F section 103, which are connected to each other through a bus to enable communication. The CPU 100 is connected to the ADF 14, the image reading section 15, the sheet feeding section 19, the operating section 18, the image forming section 17 and the image output section 16 through a bus to enable communication. The optical sensor 190 is connected to the sheet feeding section 19 to enable communication, and the punching section 161 is connected to the image output section 16 to enable communication. The communication I/F section 103 is connected to a network such as a LAN, etc., to enable communication.

The CPU 100 integrally manages and controls the image forming apparatus 1 by controlling the operation of each functional section, controlling the input and output of data between each functional section, etc. Each functional section specifically represents, the ADF 14, the image reading section 15, the sheet feeding section 19, the operating section 18, the image forming section 17, or the image output section 16. When the CPU 100 receives a print job, the CPU 100 analyzes the print job to output an instruction for the image forming processing to each functional section.

The RAM 101 is the section to store temporarily various data read by the image reading section 15 or input from the communication I/F section 103. The stored image data is processed by the CPU 100, and when necessary, transferred to the storing section 102 or to the image forming section 17.

Also, the RAM 101 stores a “print job”. The print job includes, for example, print job information about printing conditions and image data of an image of a printing object. The image data, for example, consists of data for four colors of C (cyan), Y (yellow), M (magenta), and K (black). The CPU 100 receives the print job from other communication apparatus through the communication I/F section 103. The image data may be information read by the image reading section 15 and the print job information may be information set by an input signal from the operating section 18. When the communication I/F section 103 receives the print job, the CPU 100 allows the RAM 101 to store the print job. The print job may include the image of the printing object as a file in a format such as the PDF (Portable Document Format) format, the XPS (XML Sheet Specification) format, etc. instead of the image data.

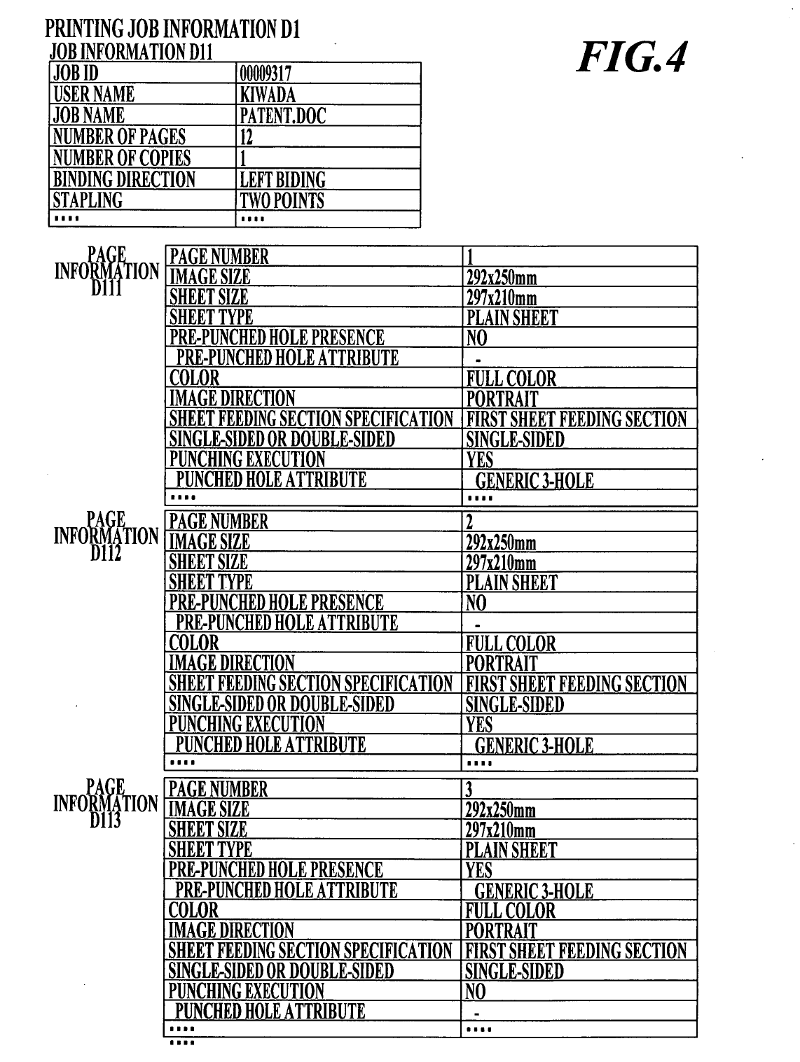

The data configuration of the print job information is shown in FIG. 4. The print job information D1 includes one piece of “job information” and one or a plurality of pieces of “page information”. The job information D11 has information about “job ID”, “user name”, “job name”, “number of pages”, “number of copies”, “binding direction”, “stapling”, etc. The page information D111 (in FIG. 4 reference numbers D111 to D113 are denoted to respective page information, though, to simplify explanations, they are hereinafter referred to as page information D111) has information about “page number”, “image size”, “sheet size”, “sheet type”, “pre-punched hole presence”, “pre-punched hole attribute”, which is subordinate information of the pre-punched hole presence, “color”, “image direction”, “sheet feeding section specification”, “single-sided or double-sided”, “punching execution”, “punched hole attribute”, which is subordinate information of the punching execution, etc.

The print job information D1 has as many pieces of page information D111 as the “number of pages” in the job information D11. The “pre-punched hole presence” in the page information D111 is information about whether a pre-punched hole is present in the printing sheet to be fed by the sheet feeding section 19, and the “punching execution” is information about whether to allow the punching section 161 to execute the punching.

The RAM 101 stores “punching function information D2”. The punching function information D2 is the information about the punched hole attribute of the punched hole that is executable by the punching section 161. When the image forming apparatus 1 is turned on and started, the CPU 100 accesses to the punching section 161 to obtain punching function information D2, and store the information in the RAM 101.

The CPU 100 may access to the punching section 161 to obtain punching function information D2, and store the information in the RAM 101, when the punching function information D2 is analyzed. Alternatively, the CPU 100 may update the punching function information D2 stored in the RAM 101 when the punching section 161 becomes unworkable for some reason.

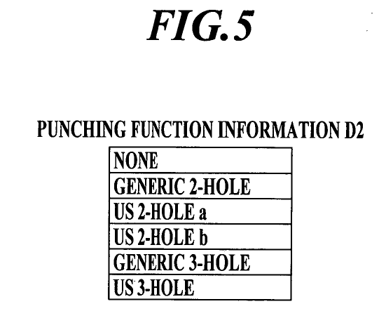

The data configuration of the punching function information D2 is shown in FIG. 5. In FIG. 5, the punching section 161 can execute the punching whose punched hole attribute is “None” “Generic 2-hole”, “US 2-hole a”, “US 2-hole b”, “Generic 3-hole”, “US 3-hole”.

The RAM 101 also stores “sheet feeding section information D4”. The sheet feeding section information D4 is the attribute information about the printing sheet stored in the sheet feeding section 19, and the RAM 101 stores pieces of the sheet feeding section information D4 corresponding respectively to the sheet feeding sections from the first sheet feeding section 19a to the fourth sheet feeding section 19d. That is, the RAM 101 stores four pieces of sheet feeding section information D4 in the image forming apparatus shown in FIG. 1.

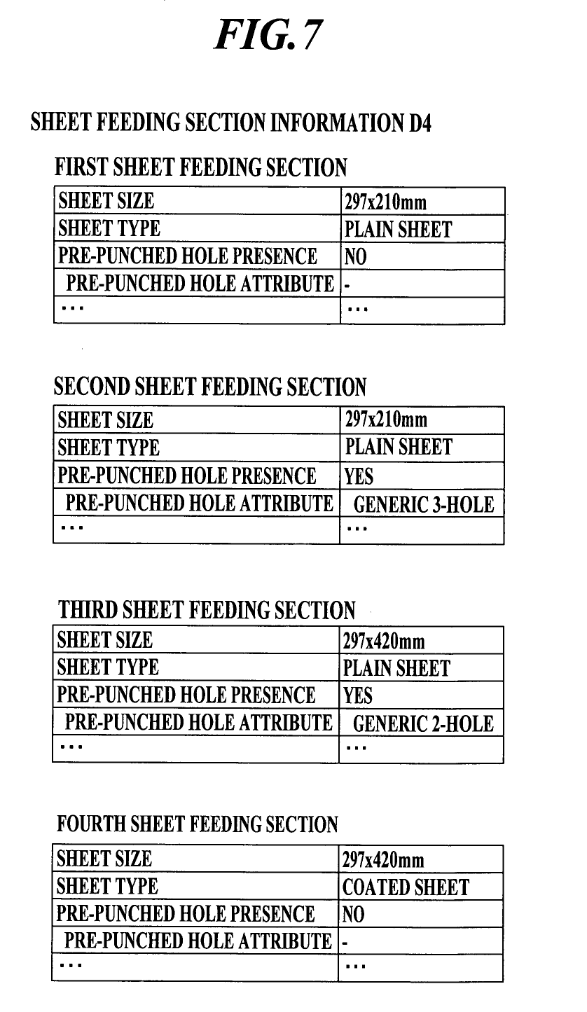

The data configuration of the sheet feeding section information D4 is shown in FIG. 7. The sheet feeding section information D4 includes “sheet size”, “sheet type”, “pre-punched hole presence”, “punched hole attribute in the sheet”, which is subordinate information of the punched hole presence etc. For example, a plain sheet with the sheet size of “297×210 mm” and no punched hole is stored in the first sheet feeding section 19a, and a plain sheet with the sheet size “297×210 mm” and with a punched hole whose attribute is “Generic 3-hole” is stored in the second sheet feeding section 19b.

When the image forming apparatus 1 is turned on and started, the CPU 100 obtains pieces of the sheet feeding section information D4 from respective sheet feeding sections 19 (first sheet feeding section 19a to fourth sheet feeding section 19d) and stores them to the RAM 101. Specifically, when the image forming apparatus 1 is started, the optical sensor 190 included in each sheet feeding section 19 detects “punched hole presence”, “punched hole attribute”, etc., of the printing sheet stored in each sheet feeding section 19. Then, the CPU 100 obtains the detected information, and stores them to the RAM 101 as sheet feeding section information D4.

The sheet feeding section 19 may not include an optical sensor 190. In such a case, the user sets the sheet feeding section information D4 on the operating section 18.

The sheet feeding section information D4 stored in the RAM 101 may be updated when the user replaces the printing sheet in the sheet feeding section 19.

Specifically, when the printing sheet in the sheet feeding section 19 is replaced, the optical sensor 190 detects the attribute of the printing sheet newly stored in the sheet feeding section 19. The CPU 100 obtains the detected information to update the sheet feeding section information D4 stored in the RAM 101.

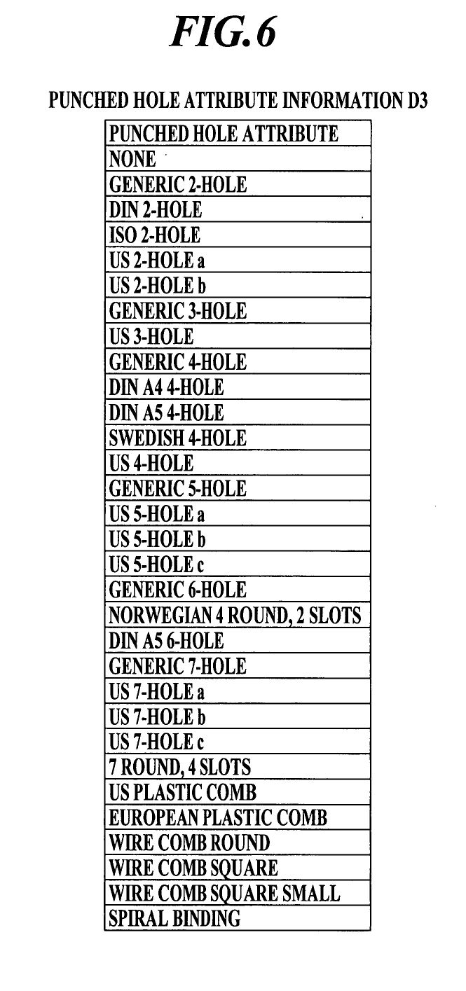

The “punched hole attribute information D3” shown in FIG. 6 is used in the parameters of “pre-punched hole attribute” and “punched hole attribute” of the page information D111, “punching function information D2”, and “pre-punched hole attribute” of the sheet feeding section information D4. The punched hole attribute information D3 is information about number, location, size, etc. of a punched hole. The punched hole attribute information D3 is stored in the storing section 102. When the image forming apparatus 1 is turned on and started, the CPU 100 reads the punched hole attribute information D3 from the storing section 102, and stores it to the RAM 101.

The storing section 102 comprises an HDD (Hard Disk Drive), a nonvolatile semiconductor memory, or the like. The storing section 102 stores a program for the CPU 100 to control each functional section, information about the processing functions of the image forming apparatus 1, etc., and the CPU 100 reads out the information and the program when necessary to execute and process them in the RAM 101.

The communication I/F section 103 comprises a LAN interface, a modem, or the like and is a functional section which performs data communication with an external apparatus such as a server, a client, other apparatus and the like through a network, etc. The communication I/F section 103 receives the print job from other communication apparatus.

The CPU 100 allows the RAM 101 to temporarily store the print job received by the communication I/F section 103. The CPU 100 executes conversion processing to convert the image data included in the print job to printing image data from which the image forming section 17 can form the image on the printing sheet. Various programs for converting the image data to printing image data from which an image can be formed is stored in the storing section 102, and the CPU 100 reads out the necessary program.

[The Specific Operation of the Image Forming Apparatus]

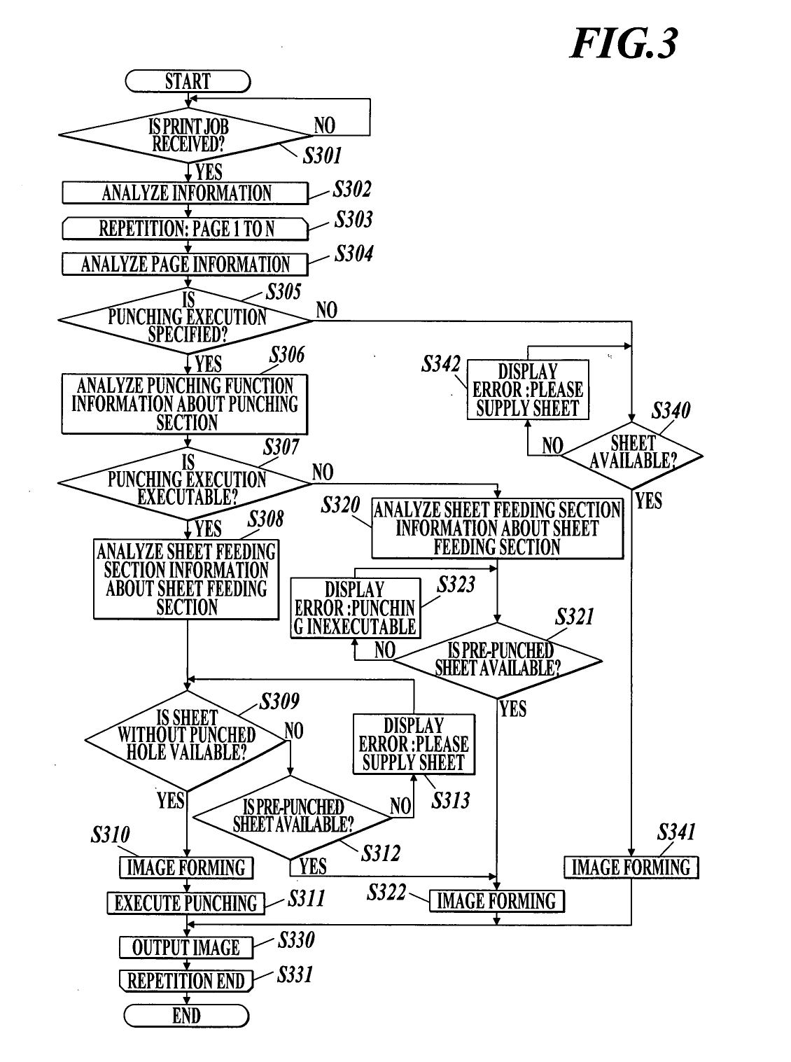

Next, the specific operation of the image forming apparatus 1 is described, with reference to FIG. 3.

In the case of a print job specifying the punching execution, the “punching execution” is “yes” and the “pre-punched hole presence” is “no” in the page information D111 of the print job information D1. A condition where the “punching execution” is “no” and the “pre-punched hole presence” is “no”, or where the “punching execution” is “no” and the “pre-punched hole presence” is “yes” may be possible in this embodiment. However, a condition where the “punching execution” is “yes” and the “pre-punched hole presence” is “yes” is restricted from being set when the page information D111 is set on the screen, etc.

After an original document sheet is placed in the ADF 14 or on the document stage of the image reading section 15 and the user sets the print job information D1 on the operating section 18, when the printing start button of the operating section 18 is pushed down, the image forming apparatus 1 starts image forming processing. Alternatively, in the case of network printing, when the print job is received from the network through the communication I/F section 103, the image forming apparatus 1 starts image forming processing.

When the print job is received (step S301: Yes), the control section 10 analyzes the job information D11 of the print job information D1 included in the print job on the RAM 101 (step S302). The control section 10 controls the operation of the print job by referring to the “number of pages” of the job information D11, etc. Specifically, when the “number of pages” is “12”, there are twelve pieces of the page information, thus the processing of step S303 to step S331 is repeated twelve times.

Next, the control section 10 analyzes the page information D111 (step S304). As described above, the processing to analyze the page information D111 (step S304) to the processing to output the image (step S330) is repeated as many times as the “number of pages” included in the job information D11 (step S303, S331). The analysis of the page information D111 (step S304) is performed each time the operation of the control section 10 returns from step S331 to step S303, in the order of the “page number” included in each page information D111. Specifically, the analysis is performed in the order of the page information D111, D112, D113 and so on.

If the “punching execution” of the page information D111 is “yes” (step S305: Yes), the control section 10 analyzes the “punching function information D2” of the punching section 161 stored in the RAM 101 (step S306).

Then, the control section 10 compares the “punching function information D2” to the “punched hole attribute” included in the page information D111. If the “punched hole attribute” is included in the “punching function information D2”, the control section 10 determines that the punching is executable (step S307: Yes).

As described above, each time the page information to be analyzed changes from the page information D111 to the page information D112 to the page information D113, etc., the control section 10 analyzes the “punching function information D2”, compares the analyzed “punching function information D2” to the “punched hole attribute” included in the page information, and determines whether or not the punching is executable. Therefore, even if the punching processing becomes inexecutable for some reason during the printing processing of a print job, the control section 10 executes a processing such as feeding a pre-punched printing sheet from the later described sheet feeding section 19, etc. so that the image forming apparatus 1 can continue the processing of the print job.

If the punching is executable(step S307: Yes), the control section 10 analyzes the sheet feeding section information D4 about the sheet feeding section 19 stored in the RAM 101 (step S308).

Then, the control section 10 refers to the sheet feeding section information D4 about the sheet feeding section 19 which matches with the “sheet feeding section specification” included in the page information D111 (step S309). If the page information D111 matches with the sheet feeding section information D4 in the “sheet size” and the “sheet type”, and if the “pre-punched hole presence” of the sheet feeding section information D4 is “no” (step S309: Yes), the control section 10 allows the feeding section 19 specified by the “sheet feeding section specification” to feed a printing sheet. Then, the control section 10 allows the image forming section 17 to form the image on the printing sheet (step S310), allows the punching section 161 to perform punching according to the “punched hole attribute” on the printing sheet (step S311), and allows the image output section 16 to output the printing sheet (step S330).

In step S309, the control section 10 refers to the sheet feeding section information D4 about the sheet feeding section 19 which corresponds to the “sheet feeding section specification” included in the page information D111. Alternatively, the sheet feeding section information D4 about the other sheet feeding section 19 may also be referred to. Specifically, the control section 10 may refer to the sheet feeding section information D4 about all of the first sheet feeding section 19a, the second sheet feeding section 19b, the third sheet feeding section 19c, and the fourth sheet feeding section 19d, and if the condition matches, the control section 10 may allow the appropriate sheet feeding section 19 to feed the printing sheet. Hereinafter, the same is to be said whenever the control section 10 refers to the sheet feeding section information D4.

In step S305, if the “punching execution” of the page information D111 is “no” (step S305: No), the control section 10 refers to the sheet feeding section information D4 about the sheet feeding section 19 corresponding to the “sheet feeding section specification” included in the page information D111, and determines whether the “sheet size”, the “sheet type”, the “pre-punched hole presence”, and the “pre-punched hole attribute” of the sheet feeding section information D4 match with the “sheet size”, the “sheet type”, the “pre-punched hole presence”, and the “pre-punched hole attribute” of the page information D111 (step S340).

If the control section 10 determines that they match with each other (step S340: Yes), the control section 10 allows the sheet feeding section 19 specified by the “sheet feeding section specification” of page information D111 to feed the printing sheet, allows the image forming section 17 to form the image on the printing sheet (step S341), and allows the image output section 16 to output the printing sheet (step S330).

If the control section 10 determines that they do not match with each other (step S340: No), the control section 10 allows the operating section 18 to display a message to request the user to load to the sheet feeding section 19 a printing sheet which meets the conditions of the “sheet size”, the “sheet type”, the “pre-punched hole presence”, and the “pre-punched hole attribute” of the page information D111 (step S342). An example of the displayed message is shown in FIG. 8. Details will be described below.

When it is determined in step S307 of judging the punching feasibility, that the punching execution is inexecutable (step S307: No), the control section 10 analyzes the sheet feeding section information D4 of the sheet feeding section 19 stored in RAM 101 (step S320).

Then, the control section 10 refers to the sheet feeding section information D4 about the sheet feeding section 19 corresponding to the “sheet feeding section specification” included in the page information D111, and determines whether or not the “pre-punched hole presence” is “yes”, and whether or not the “sheet size”, the “sheet type”, and the “pre-punched hole attribute” match respectively with the “sheet size”, the “sheet type”, and the “punched hole attribute” of the page information D111 (step S321).

This step is a determination for feeding and outputting a pre-punched printing sheet, instead of executing the punching, in the case where the punching section 161 cannot perform the required punching, but an appropriate pre-punched printing sheet with the required punched hole is previously stored in the sheet feeding section 19. If the appropriate pre-punched printing sheet with the required punched hole is not available, a message is displayed, which requests the user to set the pre-punched appropriate printing sheet with the required punched hole. Eventually, the user can obtain an output of a printing sheet with the punched hole, regardless of whether or not the punching has been executed.

When it is determined that the information matches with each other (the appropriate pre-punched printing sheet is available) (step S321: Yes), the control section 10 allows the appropriate sheet feeding section 19 to feed the printing sheet, and allows the image forming section 17 to form the image (step S322). On the contrary, when the information does not match with each other (the appropriate pre-punched printing sheet is not available) (step S321: No), the control section 10 allows the operating section 18 to display a message which requests the user to set the appropriate pre-punched printing sheet to the sheet feeding section 19 (step S323). An example of the displayed message is shown in FIG. 9. Details will be described below.

In step S309, when the appropriate plain printing sheet without a punched hole is not available in the specified sheet feeding section, specifically when the sheet feeding section information D4 about the sheet feeding section 19 does not match with the “sheet feeding section specification” included in the page information D111 in any of the “sheet size” and “sheet type”, or when the “pre-punched hole presence” of this sheet feeding section information D4 is “yes” (step S309: No), the control section 10 determines whether or not the “sheet size”, the “sheet type”, the “punched hole presence”, and the “punched hole attribute” of the sheet feeding section information D4 respectively match with the “sheet size”, the “sheet type”, the “punched hole presence”, and the “punched hole attribute” of the page information D111 (step S312).

This step is a determination for feeding and outputting a pre-punched printing sheet, instead of executing the punching, in the case where the punching section 161 can perform the required punching but a plain printing sheet without a punched hole is not available, and the appropriate pre-punched printing sheet is available. When the appropriate pre-punched printing sheet is not available, a message is displayed, which requests the user to load a plain printing sheet without a punched hole, in order to execute the punching.

When it is determined that the information matches with each other (the appropriate pre-punched printing sheet is available) (step S312: Yes), the control section 10 allows the sheet feeding section 19 to feed printing sheets and allows the image forming section 17 to form the image (stepS322). On the contrary, when the information does not match with each other (the appropriate printing sheet with a punched hole is not available) (step S312: No), the control section 10 allows the operating section 18 to display a message which requests the user to load to the sheet feeding section 19, the appropriate printing sheet without a punched hole which matches the condition (step S313). An example of the displayed message is shown in FIG. 8.

Specifically, the condition refers to a state where the “pre-punched hole presence” of the sheet feeding section information D4 is “no”, and the “sheet size” and the “sheet type” thereof match respectively with the “sheet size” and the “sheet type” of the page information D111.

In step S330, if the control section 10 outputs an image to the image output section 16 (or outputs the printing sheet), the control section 10 analyzes the next page information D112 (step S304). If there is no next page information left, the print job ends.

If the image output section 16 does not comprise the punching section 161 or does not have a function of finishing processing, it is determined in step S307 of judging the punching feasibility that the punching execution is inexecutable (step S307: No).

Even if the image output section 16 comprises the punching section 161, the determination in step S307 of judging the punching feasibility may unconditionally be that the punching execution is inexecutable, (step S307: No).

[Example of the Screen]

Next, the screen is described with reference to FIG. 8 and FIG. 9. FIG. 8 is a display screen to request the user to supply the appropriate printing sheet (hereinafter referred to as the printing sheet supply screen 180). The printing sheet supply screen 180 has a “sheet supply completed” button 180a and a “cancel printing” button 180b. The user pushes down the “sheet supply completed” button 180a, after supplying the printing sheet specified on the screen into the specified sheet feeding section 19. Alternatively, the user can cancel the printing by pushing down the “cancel printing” button 180b.

FIG.9 is a display screen (hereinafter referred to as the punching processing execution inexecutable screen 181) to request the user to supply the appropriate pre-punched printing sheet with a required punched hole, since the punching processing is inexecutable. The punching processing execution inexecutable screen 181 has a “sheet supply completed” button 180a and a “cancel printing” button 180b, as is the case with the printing sheet supply screen 180. The process responsive to pushing down each button is as same fashion as the printing sheet supply screen 180.

Hereinabove, according to the embodiment of the present invention, in the case where a print job specifies execution of punching processing, when the punching section 161 cannot deal with punching processing of a specified punched hole attribute, and the pre-punched printing sheet with a punched hole of the specified punched hole attribute is stored in the sheet feeding section 19, the image forming apparatus 1 feeds the pre-punched printing sheet and performs the printing processing.

Furthermore, when the punching section 161 can deal with the punching processing of the specified punched hole attribute, but a plain printing sheet without a punched hole is not stored in the sheet feeding section 19, and when a pre-punched printing sheet with the punched hole of the specified punched hole attribute is stored in the sheet feeding section 19, the image forming apparatus 1 feeds the printing sheet and performs the printing processing.

Thus, users can obtain a printing sheet with a punched hole, even if the punching section 161 cannot execute the punching processing. Therefore, the users need not set a pre-punched printing sheet, and change the print job information of the print job to select the set printing sheet, instead of the punching execution, and allow again the image forming apparatus 1 to form an image, etc. As a result, it becomes possible to reduce the burden on the user.

What is claimed is:

1. An image forming apparatus to perform image forming processing based on a print job, comprising:
a sheet feeding section to feed a stored printing sheet; and
a control section to allow the sheet feeding section to feed a pre-punched printing sheet with a previously formed punched hole which corresponds to a punched hole to be obtained by punching processing specified by the print job, when the image forming processing based on the print job is performed.

2. The image forming apparatus of claim 1, further comprising a punching section to perform punching processing to a printing sheet, wherein the control section determines whether or not the punching processing specified by the print job is executable on the punching section, and when the punching processing is determined to be executable, the control section allows the punching section to perform the specified punching processing to a printing sheet without the punched hole fed by the sheet feeding section, and when the punching processing is determined to be inexecutable, the control section allows the sheet feeding section to feed the pre-punched printing sheet with the previously formed punched hole which corresponds to the punched hole to be obtained by the specified punching processing.

3. The image forming apparatus of claim 2, wherein the control section determines whether or not the punching processing is executable, by referring to a punched hole attribute practical by the punching section, and presence or absence of a punched hole in the printing sheet stored in the sheet feeding section.

4. The image forming apparatus of claim 2, wherein the control section refers to presence or absence of a punched hole and an attribute of the punched hole in the printing sheet stored in the sheet feeding section, and allows the sheet feeding section to feed the pre-punched printing sheet with the previously formed punched hole which corresponds to the punched hole to be obtained by the punching processing specified by the print job.

5. The image forming apparatus of claim 4, further comprising an operating section to receive an input of the presence or absence of the punched hole and the attribute of the punched hole in the printing sheet stored in the sheet feeding section, wherein
the control section refers to the input.

6. The image forming apparatus of claim 4, wherein
the sheet feeding section includes an optical sensor to detect the presence or absence of the punched hole and the attribute of the punched hole in the printing sheet stored in the sheet feeding section, and
the control section refers to information detected by the optical sensor.

7. The image forming apparatus of claim 2, wherein the control section performs the determination with respect to each page of the printing sheet.

8. A computer-readable medium storing a program for a computer provided in an image forming apparatus which comprises a sheet feeding section to feed a stored printing sheet, and which performs image forming processing based on a print job, the program causing the computer to function as:
a control section to allow the sheet feeding section to feed a pre-punched printing sheet with a previously formed punched hole which corresponds to a punched hole to be obtained by punching processing specified by the print job, when the image forming processing based on the print job is performed.
